(19) United States
(12) Patent Application Publication
(10) Pub. No.: US 2010/0325068 A1
(43) Pub. Date: Dec. 23, 2010

(54) Method of exchanging money to people for their ingenuity, in order to stimulate the economy and creative learning

(76) Inventor: Kyle Craig Knoblauch, Levittown, PA (US)

Correspondence Address: Kyle Knoblauch, 48 Kingwood Lane, Levittown, PA, 19055, US

(21) Appl. No.: 12/456,644

(22) Filed: Jun. 19, 2009

(51) Int. Cl. G06Q 90/00

(52) U.S. Cl. 705/500

(57) ABSTRACT

An arrangement of money is organized and managed to award the projects (10) users for their ingenuity online; thus overall stimulating the economy and creative learning. Users submit pieces of artwork relative to the daily verbs (18) for their fair chance at making money each day. Any type of artists may apply.

### CROSS REFERENCE TO RELATED APPLICATIONS

None

### FEDERALLY SPONSORED RESEARCH

Not Applicable

### SEQUENCE LISTING OR PROGRAM

Not Applicable

### BACKGROUND

1. Field

This application is related to social networking online, fueled by use of a daily project that awards its participants money for their creative entries.

2. Prior Art

Social Networks and Image Hosting websites allow their users to edit, share and sell product online for free, by providing space for users on their website to keep in contact and add media. Some of the popular networks online today attract billions of members. These web sites developed a tool in order for people to stay updated, and in contact with friends, family, and people all around the world.

### SUMMARY

For the first time on the Internet a website provides projects each day, that when completed gives people a great chance at earning extra money.

### DRAWINGS

### Figure

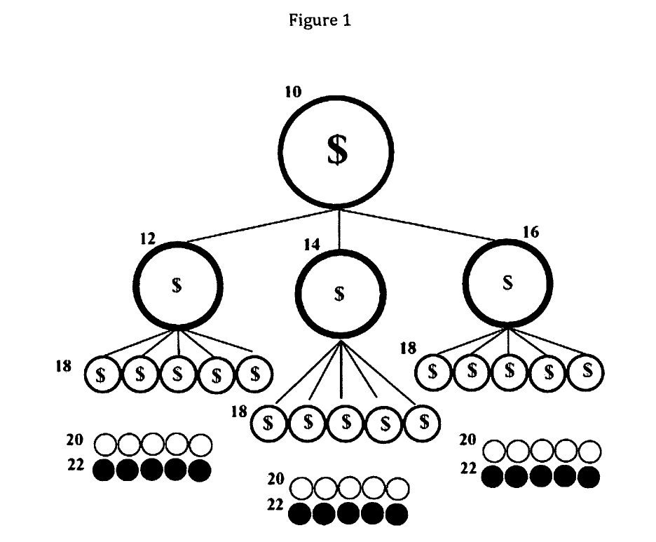

In the drawing provided, FIG. 1. A flow chart using numbers is best to identify the separate parts of the project. This best represents how users select a category worth different amounts of money from smallest to largest, and how the money will be distributed fairly.

### REFERENCE NUMERALS

FIG. 1:
10—Project Title, Adjective, and total amount of money in the project
12—Noun #1, minimum amount of money for a category
14—Noun #2, large amount of money for a category
16—Noun #3, maximum amount of money for a category
18—Five available verbs pertaining to the category's noun, each of verbs worth ⅕th of the categories amount money
20—Five separate participants per category
22—Other five that signed up, but weren't awarded

### DETAILED DESCRIPTION

### First Embodiment

FIG. 1. Shows how a participant will understand the project, and begin to participate by uploading creative submissions to their chosen category. A total amount of money (10) (subject or adjective) is divided into three unequal categories or nouns (12) (14) (16) that together equal the sum of the total money (10); the money of each of the three nouns is then divided into five different possible verbs (18) that when read simultaneously together (adjective, noun, verb), create assignments for the users to submit art work to. There are five verbs to each of the three nouns for a total of fifteen verbs in a project. The three nouns equal the sum of the total project amount (10), and the five verbs equal the sum of the total nouns (12)(14)(16). The three nouns being unequal amounts of money create low to high amounts of money for all of the fifteen verbs (If one noun is worth $25.00 and the other worth $50.00, the verbs following the $25.00 noun will be worth less amount of money then the verbs following the $50.00 noun). An even number of participants are accepted to participate in a daily project (20)(22), although rewarding only half of the participants (20) that signed up in a day, thus creating fair chances of being rewarded for each user, 50/50 or half and half.

### OPERATION

### First Embodiment

In operation the user will sign up free and play in any category long enough to be awarded up to the allowed amount of money available for free users. The user will upgrade his/her account for more access to the project. The user selects a category they want to participate in, thus reserving one of the ten available spots in that category. Ten spots are available per category, so that each user has a fair chance at winning one of the five spots. After the user has reserved their spot in a category, they have up to one week to upload their artwork to be reviewed by an administrator in order to be rewarded. The five most creative submissions (18) per category win, (one submission per verb) a total of fifteen submissions are awarded per day.

The user purchases a membership that allows more access to the other categories to earn more money available in the project, there are multiple memberships, a membership for each category (12)(14)(16), a membership for unlimited access to all three, a membership to be qualified for the end of the year scholarship drawing, and a membership to be qualified as an employee.

The project provides people around the world with the chance to make more money off the website, while a portion of the profits are donated to charitable causes, and our very own scholarship foundation.

There are many ways to build this website and have it operate according to FIG. 1. There are two scripting languages (.php and .net) that can absolutely build this website to these functioning capabilities. There is no particular scripting language to use. It is a preference decided by a web developer.

### DESCRIPTION

### Alternative Embodiment

FIG. 1 gets updated everyday with a new adjective, nouns and verbs. This maybe randomly selected or an administrator can select it. In order to keep the project fair for all users one user cannot win more than one of five spots (18) in a category (12)(14)(16). A user will enter a category and submit artwork to all five verbs, but the user may only win one of the five, leaving the four other spots available to four other users. Depending on the users purchased membership they may be allowed access to more categories (12)(14)(16) per day. There are different levels of a membership based on the users desired amount of access.

### OPERATION

### Alternative Embodiment

In operation the user signs up free, but is encouraged to purchase a membership. When their access to the project (FIG. 1) runs out the user may purchase a membership that allows more access to the richer categories (14)(16) all year in the project (10). A free user has numerous options to select from in order to keep playing. A returning user will log in and have instant access to the project (10). Businesses will host a custom online store on their personal profile, and a portion of all the networks sales goes to charitable causes.

Any form of art may be entered, as long as it is uploaded within the due date of the project The most unique entries are awarded. In order for the user to begin to play he/she must have a way of receiving payment online, credit/debit, PayPal account, or checking account.

The website will be developed as a social network, in order for all the users to keep in contact with old friends or meet new and interesting people.

The project (10) provides people around the world with the chances to make more money every day, while a portion of membership sales are donated to charitable causes.

### CONCLUSION, RAMIFICATIONS, AND SCOPE

Accordingly the reader will see that, according to one embodiment of the invention, I have provided the first type of economic stimulus in exchange for creative submissions to the project I developed. While the above description contains many specifics, these should not be construed as limitations on the scope of any embodiment, but as exemplifications of the presently preferred embodiments thereof. Many other ramifications and variations are possible within the teachings of the various embodiments. For example, the adjective (10), nouns (12) (14) (16) and verbs (18) may be organized in whichever way to create criteria for the project. Words may even be substituted by an activity, etc. The money being dispersed does not have to be of any particular amount, therefore creating room for expansion and more users to play per day. This project can be expanded thus to award more people each day when needed. Thus the scope of the invention should be determined by the appended claims and their legal equivalents, and not by the examples given.

I claim:

1. Providing any type of artist with chances at earning money each day, by allowing all users a fair opportunity at winning extra money.

2. In closure of claim 1 wherein said fair opportunity, each participant in a category is 1 of 10 competing for 5 equal possible awards.

3. In closure of claim 2 where in said category, no participant in a category can win more than 1 of the 5 possible awards.

4. In closure of claim 1 where in said with chances at earning money, one can submit 5 pieces to all 3 categories a day relative to the project at the time, in order to raise their overall chances of being awarded.
